(19) United States
(12) Patent Application Publication
(10) Pub. No.: US 2026/0337946 A1
(43) Pub. Date: Oct. 29, 2026

(54) COMBINED DRAIN AND VENTILATION UNIT FOR A ROUGH OPENING

(71) Applicant: Neptun Merverdi AS, STAVANGER (NO)

(72) Inventor: Alexander Nicolai Tønnessen, STAVANGER (NO)

(73) Assignee: Neptun Merverdi AS, STAVANGER (NO)

(21) Appl. No.: 19/485,516

(22) PCT Filed: Jul. 3, 2024
(86) PCT No.: PCT/NO2024/050154

§ 371 Date: Nov. 18, 2025

(30) Foreign Application Priority Data
Jul. 5, 2023 (NO) 20230754

(51) Int. Cl. E03F 5/04; E06B 1/70

(52) U.S. Cl. CPC E03F 5/0407; E06B 1/70

(57) ABSTRACT

A drain for a rough opening having a main body including a channel, a first side flange arranged at a first end wall of the channel, and a second side flange arranged at a second end wall. The first and the second side flange extending higher than the first and second end wall. A drain system for the rough opening, wherein the drain system includes the drain and a membrane for fastening to at least the side surfaces of the first side flange and the second side flange. A method is for installing a drain in the rough opening, where at least one side jamb of a door frame is coupled to the rough opening such that the at least one side jamb is arranged above and across a portion of the channel at one of the channel end walls.

### CROSS-REFERENCE TO RELATED APPLICATIONS

This application is the U.S. national stage application of International Application No. PCT/NO2024/050154, filed Jul. 3, 2024, which international application was published on Jan. 9, 2025, as WO 2025/009979 in the English language. The International Application claims priority to Norwegian Patent Application No. 20230754, filed on Jul. 5, 2023. The international application and Norwegian application are both incorporated herein by reference, in their entirety.

### BACKGROUND

Known linear drains typically form an elongate recessed channel, and may be implemented, for example, along a portion of a wall or at the threshold of a shower enclosure. In some examples, linear drains are implemented within a structure at the base of a threshold, for example at the boundary between a wet room and a dry room. In such examples, when the wet room is in use, excess water, from a shower, for example, may be present on the floor of said room and begin flowing towards the dry room where it may potentially cause damage. The linear drain arranged at the boundary between these two rooms prevents this water from flowing through to the dry room. Instead, before reaching the dry room, the water flows through a cover of the drain, for example a grate, and is drained away via piping to which the drain is connected, for example to the main shower drain.

Known linear drains, however, have limitations in their application due to unwanted water intrusion around the sides of the drain when located at the base of a doorway, for example. This can lead to water damage of the surrounding structure, having undesirable implications for the longevity and safety of such an arrangement.

The present disclosure seeks to address the problems associated with the prior art.

### SUMMARY

The invention is defined by the independent patent claims. The dependent claims define advantageous embodiments of the invention.

The term “concrete”, when used throughout this specification, may refer to any building material which may initially be poured as a fluid, for example a solid-liquid mixture, and then sets, cures, and/or hardens into a solid. Examples of such building materials include levelling compounds, for example cement-based levelling compounds and epoxy-based levelling compounds. These building materials may be known as pourable and/or curable building materials.

According to a first aspect of the disclosure, there is provided a drain for a rough opening, wherein:
the drain comprises:
   an imaginary width axis;
   an imaginary depth axis; and
   an imaginary height axis, wherein:
a first width direction extends parallel to the width axis in a first direction;
a second width direction extends opposite the first width direction, in a second direction;
a first depth direction extends parallel to the depth axis in a third direction;
a second depth direction extends opposite the first depth direction, in a fourth direction;
a first height direction extends parallel to the height axis, in a fifth direction; and
a second height direction extends opposite the first height direction, in a sixth direction;
   the drain further comprises:
   a main body comprising:
a channel wall forming a channel extending in the first width direction, the channel wall comprising:
   first and second channel side walls extending in the first with direction;
   and
   first and second channel end walls extending between the first and second channel side walls in the first depth direction;
a first side flange arranged at the first end wall, the first side flange extending further in the first height direction than the end wall; and
a second side flange arranged at the second end wall, the second side flange extending further in the first height direction than the first end wall. Further:
   the first side flange has a width extending in the first width direction and a thickness extending in the first depth direction, the width being larger than the thickness;
   the second side flange has a width extending in the first width direction and a thickness extending in the first depth direction, the width being larger than the thickness;
   the first side flange projects beyond the channel in the first width direction;
   the second side flange projects beyond the channel in the second width direction;
   the first side flange and second side flange are each provided with a side surface extending in the first width direction and the first height direction.

Advantageously, the side flanges and the ends of the main body may allow for correct positioning of the drain relative to the vertical edges of a rough opening. The vertical edges of the main opening may comprise vertical supports of one or more building material, for example wood, metal, brick, and/or concrete. As a specific example, the vertical supports may be profiles of aluminium. This may enable the drain to be installed at an early stage of construction before a concrete floor has been poured and waterproofing completed. In one embodiment the side flanges are provided with holes for fastening the drain to the vertical supports or to a wall, for example a wall made of brick or concrete in which the rough opening is located.

Optionally, the drain may comprise a front flange extending:
in the first width direction between the first side flange and the second side flange; and
in the first depth direction, wherein
   the front flange comprises an upper surface extending in the first width direction and the first depth direction; and
   the upper surface of the front flange and each of the side surfaces of the first and second side flanges provide an L-shaped surface for fastening a membrane thereto.

Advantageously, the front flange and the side flanges may provide a surface for secure fastening of a membrane to the drain, enabling the drain to be sufficiently waterproofed along its length. The membrane may provide a secure seal when fastened thereto, preventing unwanted water intrusion around the edges of the vertical supports, or side edges of the rough opening, and into the surrounding structure in which the drain is installed.

Optionally, the main body may comprise a recessed channel.

Advantageously, this may increase the volumetric capacity of the drain, preventing, or at least delaying, overflow if the incoming water flow rate is greater than the drainage flow rate of the drain.

Optionally, the recessed channel may comprise a drainage aperture for draining water therethrough.

Optionally, the recessed channel may further comprise a channel base; and the aperture is located on the channel base.

According to a second aspect of the disclosure, there is provided a drain system for a rough opening, comprising: a drain according to the first aspect of the disclosure; and a membrane for fastening to at least the side surfaces of the first side flange and the second side flange.

Optionally, the drain system may comprise the front flange described above in relation to the first aspect of the disclosure, the membrane being for fastening to the side surfaces of the first and second side flange and the upper surface of the front flange.

Optionally, the drain system may comprise a membrane retention piece for fastening a membrane to the drain.

Advantageously, the membrane retention piece enables a membrane to be securely fastened to the drain, preventing unwanted water intrusion around the edges of the vertical supports or side edges of the rough opening and into the structure in which the drain is installed.

Optionally, the drain system may further comprise a membrane fastened to the drain by the membrane retention piece. Advantageously, this may securely waterproof the surrounding structure, preventing unwanted water intrusion.

Optionally, the drain system may comprise a finishing piece extending along one of the channel side walls.

Optionally, the finishing piece is positioned in a recess extending in the first with direction.

Advantageously, the finishing piece forms a boundary between the drain and a top layer, for example tiling or wooden flooring, of a surface in which the drain is installed and/or to which the drain is adjacent. The finishing piece may be planar. The finishing piece may be inserted adjacent an upper surface of at least one channel side wall. An upper surface of the finishing piece may be coplanar with an upper surface of a channel side wall, for example the upper surface of the second channel side wall. The finishing piece may be a first finishing piece.

Optionally, the drain system may be provided with a finishing piece groove or recess for receiving the finishing piece.

The finishing piece groove is provided on a portion of an outward facing surface of one of the channel side wall. The finishing piece may be inserted into the finishing piece groove. The finishing piece groove or recess may be considered as a notch cut out of one of the channel side walls.

Optionally, the drain system may be provided with a second finishing piece.

Optionally, there may be two finishing piece grooves: a first finishing piece groove similar to that described above, and a second finishing piece groove. The first finishing piece groove may be considered as a slit extending through the upper surface of the front flange, extending along and adjacent to the channel side wall, more specifically the first channel side wall.

When in place, each finishing piece extends along each of the channel side walls. One finishing piece extends between the side flanges along an outer side surface of the first channel side wall. If there are two or more finishing pieces, two or more of the finishing pieces may have coplanar upper surfaces.

Optionally, the drain system further comprises a moisture detector.

Advantageously, this can be used to detect moisture in the channel. For example, this provides the information for a user's notification once a certain moisture threshold is reached. This alerts a user to take action and potentially prevent damage or further damage from occurring due to flooding.

According to a third aspect of the disclosure, there is provided: A method of installing a drain in a rough opening, comprising the steps of:
providing the drain system according to the second aspect of the disclosure;
positioning the drain in the rough opening between a first space and a second space, the first space being a wet room, such that the first side flange and the second side flange project into the first space in the first depth direction;
pouring concrete on a floor up to a portion of the drain;
fastening a membrane to the drain; and
coupling at least one side jamb of a door frame to the rough opening such that the at least one side jamb is arranged above and across a portion of the channel at one of the channel end walls.

Advantageously, this may allow the drain to be installed at an early stage of construction before the concrete floor has been poured and waterproofing completed. This may allow for a secure fastening of the drain to the vertical supports of the rough opening, enabling effective waterproofing around the drain, and reduces the margin of error when estimating the height to which concrete should be poured when levelling the floor.

Advantageously, this may provide for a level concrete floor at the desired height.

Advantageously, this may securely waterproof the surrounding structure, preventing unwanted water intrusion.

Optionally, the membrane may be fastened to the drain using the membrane retention piece.

Optionally, the rough opening may be formed by vertical supports, and the first side flange and the second side flange are each fastened to a respective vertical support.

Optionally, the concrete may be poured on the floor until the concrete is flush with the upper surface of the front flange.

Optionally, the finishing piece may be positioned in the recess and the finishing piece is selected such that a top surface of the finishing piece is coplanar with a top layer of a surface in which the drain is installed and/or to which the drain is adjacent.

Optionally, a tile adhesive may be added to cover a portion of an upper surface of the membrane and a first section of the membrane retention piece, as well as covering a portion of a side surface of the finishing piece. A tiling is then added on top of the tile adhesive to cover the tile adhesive, terminating at the side surface of the finishing piece. Optionally, the top surface of the tiling is coplanar with the top surface of the finishing piece.

### BRIEF DESCRIPTION OF THE DRAWINGS

In the following is described examples of preferred embodiments illustrated in the accompanying drawings, wherein:

FIG. 1A shows a perspective view of an example drain;

FIG. 1B shows a side plan view of the drain of FIG. 1;

FIG. 2A shows a top plan view of the drain of FIG. 1;

FIG. 2B shows a front plan view of the drain of FIG. 1;

FIG. 3A shows a perspective view of a first example drain system;

FIG. 3B shows a perspective view of a second example drain system;

FIG. 4A shows a perspective view of a third example drain system;

FIG. 4B shows a schematic diagram of a fourth example drain system;

FIG. 5A shows a first perspective cutaway view of an example doorway system comprising a fifth example drain system;

FIG. 5B shows a side cross-sectional view of the doorway system of FIG. 5A;

FIG. 6A shows a second perspective cutaway detail view of the doorway system of FIG. 5A;

FIG. 6B shows a third perspective cutaway detail view of the doorway system of FIG. 5A;

FIG. 7A shows a schematic diagram of an example method of installing the doorway assembly of FIG. 5A;

FIG. 7B shows a first step of the method of FIG. 7A;

FIG. 8A shows a second step of the method of FIG. 7A;

FIG. 8B shows a third step of the method of FIG. 7A;

FIG. 9A shows a fourth step of the method of FIG. 7A; and

FIG. 9B shows a fifth step of the method of FIG. 7A.

### DETAILED DESCRIPTION OF THE DRAWINGS

Any positional indications refer to the position of features shown in the figures.

In the figures, same or corresponding elements are indicated by same reference numerals. For clarity reasons, some elements may in some of the figures be without reference numerals.

A person skilled in the art will understand that the figures are just principal drawings. The relative proportions of individual elements may also be distorted.

### Drain 100

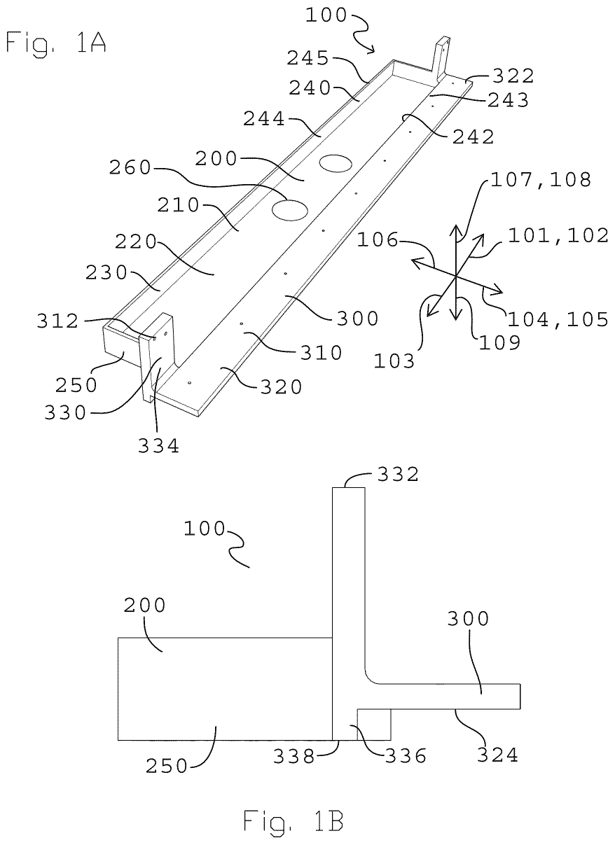

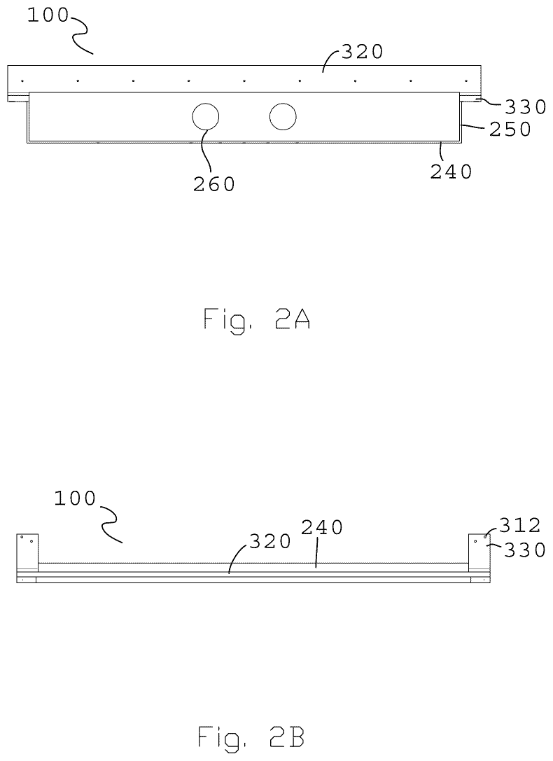

Reference is now made to FIGS. 1 to 2. A drain 100 comprises a main body 200 and a drain collar 300. In some examples, the drain 100 shields the base of a rough opening from water intrusion. In some examples, the drain 100 provides a flow path therethrough for the water. In some examples, the drain 100 both shields the base of a rough opening from water intrusion and also provides a flow path therethrough for the water. The drain 100 may be known more generally as a device. The drain 100 may also be considered as a threshold. Further, the drain 100 may be known as a combined drain and ventilation unit.

The drain collar 300 has a dual purpose, being used as a marker up to which concrete is poured when levelling a concrete floor, and also being used to prevent uncontrolled water intrusion under the main body 200. For example, a membrane may be fastened to the drain collar 300 and may divert incidental water towards a drain, away from less water-resistant areas such as a wooden support of a rough opening.

The drain 100 is for a rough opening, for example a window or a door. More specifically, the drain 100 is for an interior rough opening, for example a doorway between a wet room such as a bathroom and a dry room such as a hallway. The rough opening may form part of a boundary between a first space and a second space.

The drain 100 comprises an imaginary width axis 101, an imaginary depth axis 104, and an imaginary height axis 107. A first width direction 102 extends parallel to the width axis 101 in a first direction, and a second width direction 103 extends opposite the first width direction 102, in a second direction. A first depth direction 105 extends parallel to the depth axis 104 in a third direction, and a second depth direction 106 extends opposite the first depth direction 105, in a fourth direction. A first height direction 108 extends parallel to the height axis 107, in a fifth direction, and a second height direction 109 extends opposite the first height direction 108, in a sixth direction.

The drain 100 is formed as one integral piece. In other words, the main body 200 and the drain collar 300 is formed as one integral piece. The drain 100 may be monolithic, i.e. constructed using one material.

### Main Body 200

The main body 200 comprises a channel 210.

The channel 210 comprises a channel base 220 and a channel wall 230, fluidly enclosing and defining the channel 210. The channel 210 may be considered as being recessed.

The channel wall 230 prevents unwanted water leakage from sides of the main body 200. The channel wall 230 may be considered as a dam portion of the drain 100. The channel wall 230 comprises two channel side walls 240 and two channel end walls 250. The channel 210, in the present example, is elongate, meaning that the channel side walls 240 are longer than the channel end walls 250.

The channel side walls 240 may be considered as front and rear dams of the drain 100. The channel side walls 240 extend in the first width direction 102, between the channel end walls 250. In the present example, there is a first channel side wall 242 and a second channel side wall 244. The first channel side wall 242 may be considered as a front dam, and the second channel side wall 244 may be considered as a rear dam. The second channel side wall 244 has an upper surface 245 which is offset vertically from an upper surface 243 of the first channel side wall 242. In the present example, second channel side wall 244 is taller than the first channel side wall 242. This means that the second channel side wall 244 extends further in the first height direction 108. In some examples, however, the first and second channel side walls 242, 244 are the same height.

The channel end walls 250 may be considered as side dams of the drain 100. The channel end walls 250 extend in the first depth direction 105.

The channel 210 further comprises two drainage apertures 260 for draining water. The drainage apertures 260 are located on the channel base 220. However, in some examples, there may be no drainage apertures 260. Instead, a user may remove portions of the channel base 220, for example by drilling or sawing, to create at least one drainage aperture 260. More specifically, a user may remove portions of the channel base 220 which are thinner or weakened when compared with other areas of the channel base 220 to create at least one drainage aperture 260. In some examples, there are one or more than two drainage apertures 260 provided along the channel base 220, for example three, four, five, or six. In use, typically all but one of these drainage apertures 260 will be covered.

### Drain Collar 300

The drain collar 300 comprises at least one flange portion 310. The flange portion 310 comprises at least one front flange 320 and at least one side flange 330. In the present embodiment, there is one front flange 320 and two side flanges 330.

The flange portion 310 may comprise at least one through hole 312 for facilitating the attachment of the drain 100 to vertical supports, such as studs of a rough opening. In the present embodiment, the side flanges 330 each have two through holes 312. In other examples, the flange portion 310 does not comprise any through holes 312 and is instead attached to vertical supports using a fastening means such as adhesives. In other examples, the drain 100 is positioned within the rough opening and supported to a predetermined level until the drain 100 is fixed by concrete as described elsewhere in the disclosure.

### Front Flange 320

The front flange 320 provides a surface to which the membrane 500 is fastened. As can be seen in FIGS. 1 and 2, the front flange 320 extends out from one of the channel side walls 240. The front flange 320 may be considered as extending laterally and/or horizontally. More specifically, the front flange 320 is planar, extending primarily in the first width direction 102 and the first depth direction 105. The front flange 320 extends more in the first with direction 102 than the first depth direction 105. The front flange 320 comprises an upper surface 322 which is coplanar with the upper surface 243 of the first channel side wall 242.

### Side Flange 330

The side flanges 330 also provide a surface to which the membrane 500 is fastened, as well as providing an opposite surface facing and abutting vertical supports of a rough opening, for example studs. The side flanges 330 are arranged at ends of the main body 200 of the drain 100. More specifically, the side flanges 330 extend out from the channel end walls 250. The side flanges 330 also provide a surface to which the membrane 500 is fastened. The side flanges 330 may be considered as extending vertically. More specifically, the side flanges 330 are planar, extending primarily in the first width direction 102 and the first height direction 108. Each side flange 330 extends more in the first height direction 108 than the first width direction 102. In other words, each side flange 330 extends perpendicularly to the front flange 320.

The side flange 330 extends beyond an upper surface 322 of the front flange 320 such that an upper surface 332 of the side flange 330 is offset from the upper surface of the front flange 320. The side flange 330 extends at least 50 millimetres above the channel wall 230, for example at least 75 millimetres above the channel wall 230 or at least 100 millimetres above the channel wall 230.

A lower portion 336 of each side flange 330 extends beyond a lower surface 324 of the front flange 320 such that a lower surface 338 of the side flange 330 is offset from the lower surface 324 of the front flange 320.

Together, the front flange 320 and the side flanges 330 form a bracket to which a membrane may be fastened. The bracket may be considered as L-shaped in some examples, as can be seen in the figures, when the front flange 320 and the side flanges 330 extend perpendicularly to one another, best seen in FIG. 1B.

### Drain System 110, 120, 130, 140, 150

A drain system in accordance with the present disclosure comprises the drain 100 and at least one of a membrane retention piece 400, a membrane 500, a cover 610, a drain adapter 620, a valve 630, a finishing piece 640, and a moisture detector 700. The drain system may be sold fully assembled, partially assembled, or unassembled. The drain system may be known as a device system. The drain system may be known as a drain assembly, for example when assembled.

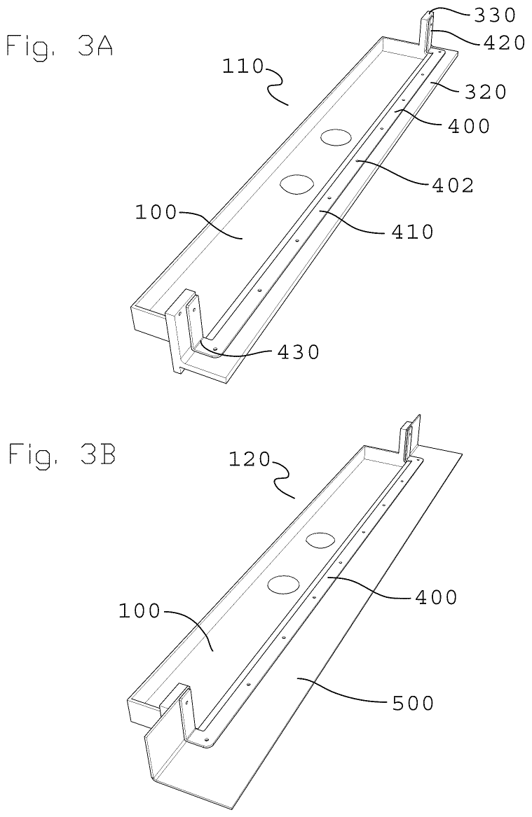

FIG. 3A shows a first example drain system 110, comprising the drain 100 and the membrane retention piece 400.

FIG. 3B shows a second example drain system 120. The second example drain system 120 is identical to the first drain system 110, aside from that it further comprises the membrane 500.

### Membrane Retention Piece 400

The membrane 500 is fastened to the flange portion 310 using the membrane retention piece 400. The membrane retention piece 400 has through holes 402 and the flange portion 310 has corresponding through holes in the front flange 320 and the side flanges 330, enabling a mechanical fastening of the membrane retention piece 400 and the flange portion 310, for example using screws. The seal formed between the membrane 500 and each of the flange portion 310 and the membrane retention piece 400 is watertight, ensuring water encountering a top surface of the membrane 500 cannot leak to a bottom surface of the membrane 500 and into the surrounding structure into which the drain 100 is installed.

The membrane retention piece 400 comprises a first section 410, a second section 420, and a corner section 430. In the present embodiment, there is one first section 410, two second sections 420, and two corner sections 430. The first section 410 is for fastening the membrane 500 to the front flange 320. In the present example, the first section 410 is planar. The first section 410 extends primarily in the first with direction 102 and the first depth direction 105. The first section 410 extends more in the first width direction 102 than in the first depth direction 105. In the present example, the second section 420 is also planar. The second section 420 extends primarily in the first width direction 102 and the first height direction 108. The second section 420 extends more in the first height direction 108 than in the first width direction 102. The corner section 430 connects the first section 410 and the second section 420. The membrane retention piece 400 may be considered as being U-shaped.

### Membrane 500

The membrane 500 is a waterproof membrane, but in other embodiments may be a water-resistant membrane. The membrane 500 is a flexible sheet. The membrane 500 is fastened to the flange portion 310. More specifically, the membrane 500 is fastened to the upper surface 322 of the front flange 320 and a side surface 334 of the side flange 330.

In some examples, the membrane 500 is not attached using the membrane retention piece 400 and is instead fastened in a watertight manner directly to the drain collar 300 using, for example, a water-resistant adhesive.

Further information regarding the connection of membrane 500 to a wall membrane during installation is given in the description relating to the door system 800.

### Cover 610

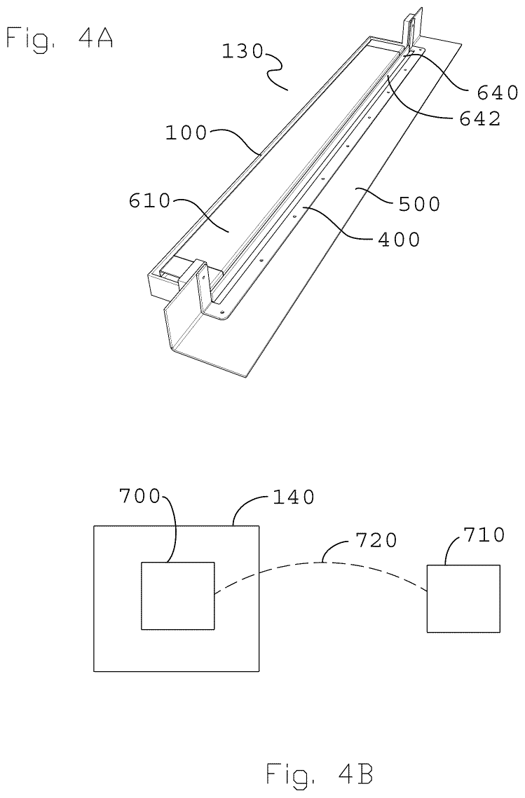

FIG. 4A shows a third drain system 130. The third drain system 310 is identical to the second drain system 120, aside from that it further comprises a cover 610.

The cover 610 as seen in FIG. 4A has a continuous, smooth surface. In other examples, the cover 610 may be a grate, or tiled. The cover 610 is removable. When installed, the cover 610 is flush with the surrounding floor. This enables, for example, wheelchair users to pass over the drain 100 without being obstructed. Furthermore, this enables a sliding door to slide over the cover 610, for example when opening the sliding door, without being obstructed. A swing door may also close such that it is positioned over the cover 610.

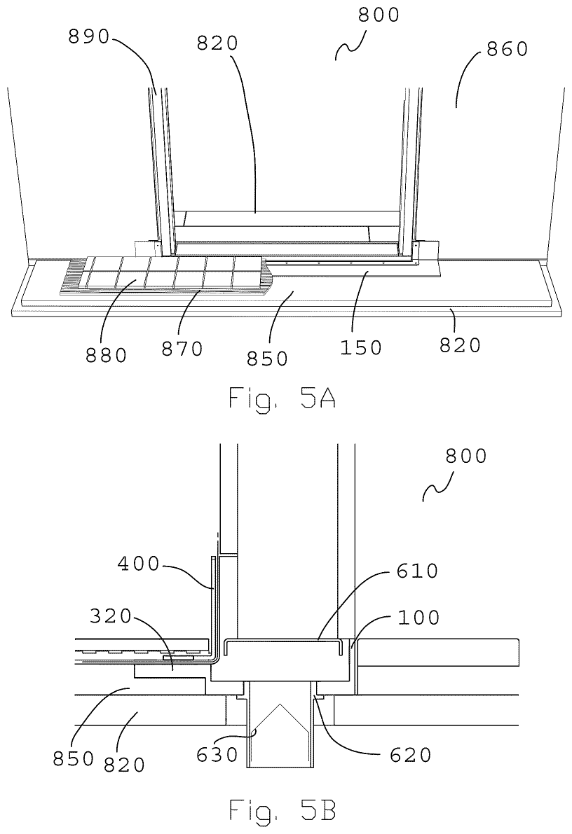

The cover 610 may be arranged in relation to the channel 210 in a variety of different ways. The cover 610 may be supported by the upper surfaces 243, 245 of the channel side walls 242, 244. In other examples, the cover 610 sits within the channel wall 230, supported by the channel base 620. For example, the cover 610 may be supported by supports located within the channel 210. Also, for example, the cover 610 may have supports provided on its lower surface, supported by the channel base 620. Supporting the cover 610 within the channel 210 enables the cover 610 to have an upper surface which is smaller than a surface defined by an interior perimeter of the channel wall 230. This means that water and/or air may pass around at least one side of the cover 610 through to the channel 210 via at least one fluid gap. The cover 610 may be arranged such that there is at least one fluid gap extending along and adjacent at least a portion of each of the channel side walls 240, see FIG. 5B.

The cover 610 may have one or more through holes (not shown) for enabling water and/or air to pass through to the channel 210.

### Drain Adapter 620

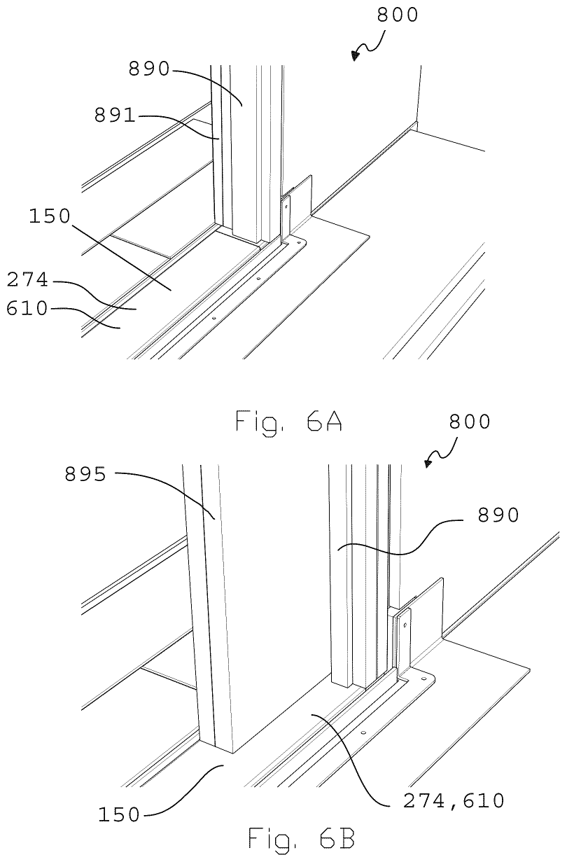

Some embodiments of the drain system, such as the fifth example drain system 150 detailed below in relation to the door system 800 and shown in FIGS. 5 and 6, further comprise a drain adapter 620. The drain adapter 620 is for enabling a watertight connection of the drain 100 to piping, for example a residential plumbing system. The drain adapter 620 is in fluid communication with at least one drainage aperture 260 of the main body 200 when mounted.

### Valve 630

In some examples, the drain system may further comprise a valve 630. In the fifth example drain system 150, the valve 630 is arranged at least partially within the drain adapter 620, as can be seen in FIG. 5B.

The valve 630 is a one-way valve and forms an odour lock for preventing undesirable odours from emanating from the piping to which the drain 100 is connected to whilst also enabling water to be drained from the drain 100.

### Finishing Piece 640

The third, fourth, and fifth drain systems 130, 140, 150 further comprise at least one finishing piece 640. The finishing piece 640 forms the boundary between the drain 100 and a top layer, for example tiling or wooden flooring, of a surface in which the drain 100 is installed and/or to which the drain 100 is adjacent. The finishing piece 640 is planar. The finishing piece 640 extends along one of the channel side walls 240. The finishing piece 640 is inserted adjacent an upper surface of at least one channel side wall 240. An upper surface of the finishing piece 640 may be coplanar with an upper surface of a channel side wall 240, for example the upper surface 245 of the second channel side wall 244.

In the third example drain system 130, the finishing piece 640 is a first finishing piece 642. In further example drain systems, there is further provided a second finishing piece.

The drain 100 comprises at least one finishing piece groove (not shown). The finishing piece groove is provided on a portion of an outward facing surface of one of the channel side wall 240. The finishing piece 640 may be inserted into the finishing piece groove. The finishing piece groove may be considered as a notch cut out of one of the channel side walls 240.

In some examples, there may be two finishing piece grooves: a first finishing piece groove similar to that described above, and a second finishing piece groove (not shown). The first finishing piece groove may be considered as a slit extending through the upper surface 322 of the front flange 320, extending along and adjacent to the channel side wall 240, more specifically the first channel side wall 242.

When in place, each finishing piece extends along each of the channel side walls 240. In the present example, one finishing piece 640 extends between the side flanges 640 along an outer side surface of the first channel side wall 242. If there is provided more than one finishing pieces 640, each finishing piece 640 may have coplanar upper surfaces.

### Moisture Detector 700

A fourth example drain system 140 can be seen schematically represented in FIG. 4b. The fourth drain system 140 is identical to the third drain system 120, aside from that it further comprises the moisture detector 700.

As can be seen, the moisture detector 700 is arranged at least partially within the drain 100. In some embodiments, for example, the moisture detector 700 is arranged within the main body 200, for example in the channel 210.

The moisture detector 700 may be connected to an alert system 710, for example via a wireless connection 720 such as Bluetooth. The alert system 710 is for alerting a user to the presence of moisture in the channel 210 once a certain moisture threshold is reached.

### Doorway System 800

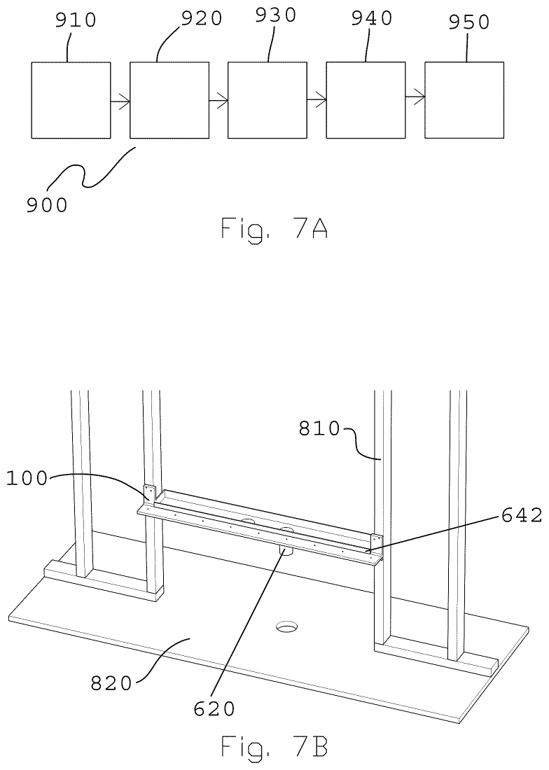

FIGS. 5 and 6 show a doorway system 800. The doorway system 800 may form part of a boundary between a first space, for example a first room, and a second space, for example a second room. In the present example, the first space is a wet room, and the second space is a dry room. The doorway system 800 comprises a fifth example drain system 150, vertical supports 810 (first shown in FIG. 7B), a floor 820, a piping system (not shown), concrete 850, walls 860, tile adhesive 870, tiling 880, a door frame 890 comprising at least one side jamb 891, and a door 895.

The fifth example drain system 150 is identical to the third drain system 130 aside from that it further comprises the drain adapter 620, the valve 630, and the first finishing piece 642.

In some examples, the tiling 880 may be another type of finished flooring, for example wood flooring or linoleum.

In the present example, the door frame 890 comprises two side jambs 891. One of more of the side jambs 891 of the door frame 890 are arranged to at least partially covering the channel 210. Both the door frame 890, specifically the side jambs 891, and the drain 100 may be fixed to the same vertical support 810 or to other features forming the rough opening.

A wall membrane (not shown) may extend along the base of the walls 860 at a predetermined height, for example 50 millimetres, from an upper surface of the tiling 880. The membrane 500 may be connected to the wall membrane such that together the wall membrane and the membrane 500 form a watertight seal along the wall 860 in which the rough opening which the drain 100 is installed within is arranged.

In the example doorway system 800, the door 895 is shown as a sliding door. In other arrangements, the door 895 may be another type of door, for example a swing door.

FIG. 6A shows a door frame 890 with a side jamb 891 adapted to receive a swing door (not shown). FIG. 6B shows a door frame 890 adapted to a sliding door 895.

As can be seen in FIG. 6B, the door 895 may extend, in some configurations, for example a closed configuration, over the drain system 150.

In some examples, the door 895 may be arranged with a gasket (not shown) extending along its lower surface. When the door 895 is in a closed or partially-closed configuration, the gasket may extend towards the cover 610. In some examples, the gasket may be in contact with the upper surface 274 of the cover 610. Arranging a gasket along the lower surface of a door facilitates soundproofing of the doorway assembly 800, blocking soundwaves from travelling between the door 895 and the cover 610. Air, however, may continue to flow between the fluid gaps arranged at either side of the cover 610, through the channel 210. This means that the doorway assembly 800 may effectively block sound whilst also enabling airflow therethrough.

### Method of Installation 900

An example method 900 of installing the fifth example device system 150 in a room will now be described. As can be seen in FIG. 7A, the method 900 comprises at least one of a first step 910, a second step 920, a third step 930, a fourth step 940, and a fifth step 950. In the first step 910, shown in FIG. 7B, a user assembles vertical supports 810 on a floor 820. The vertical supports may be studs. The vertical supports 810 form part of a rough opening. The rough opening forms at least part of a boundary between a first space and a second space.

Next, a user, for example a plumber, mounts the drain adapter 620 to the drain 100.

The user then positions, mounts, or fastens, the drain 100 in-between the vertical supports 810. More specifically, the drain 100 is positioned in-between opposing side surfaces of the vertical supports 810. The drain 100 may be mounted using screws. The screws are inserted through the through holes 312 of the flange portion 310 and into the vertical supports 810. The drain 100 may be mounted 25 millimetres higher than a shower drain, for example.

The user then attaches the first finishing piece 642 in place in the drain 100 in the first finishing piece groove. The user then connects piping underneath the floor 820 to the drain adapter 620. The drain 100 is now fluidly connected to the piping system.

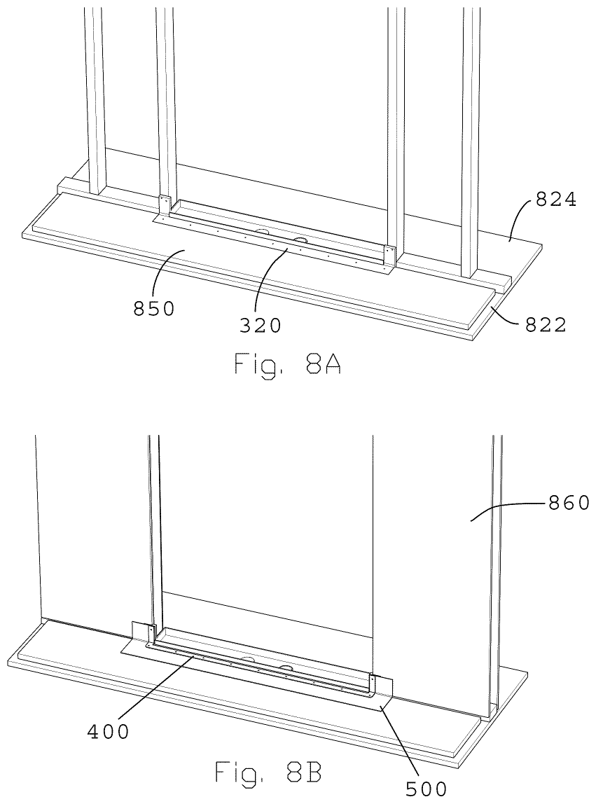

In the second step 920, shown in FIG. 8A, a user, for example a tiler, then applies concrete 850. The concrete 850 may be known as levelling concrete 850. The concrete 850 is poured onto a first side 822 of the floor 820. The first side 822 of the floor 820 corresponds with the wet room. The concrete 850 is poured up to a portion of the drain 100. More specifically, the concrete 850 is poured up to the upper surface 322 of the front flange 320 of the drain 100. The concrete 850 provides support for the drain 100. The concrete 850 may be poured and left to dry in several stages. The concrete 850 may fix the drain 100.

In the third step 930, shown in FIG. 8B, walls 860 are then assembled by a user, for example a carpenter. The walls 860 are mounted on the floor such that they extend out from the vertical supports 810.

The membrane 500 is then attached to the drain 100. The membrane 500 extends at least 50 millimetres above the channel wall 230, for example at least 75 millimetres above the channel wall 230 or at least 100 millimetres above the channel wall 230. The rest of the wet room may also be waterproofed in this step, for example by installing a membrane around its interior perimeter. The membrane retention piece 400 is then used to fasten the membrane 500 to the drain 100, using screws. As mentioned above, the membrane 500 is fastened to the upper surface 322 of the front flange 320 and the side surface 334 of the side flange 330 of the drain 100.

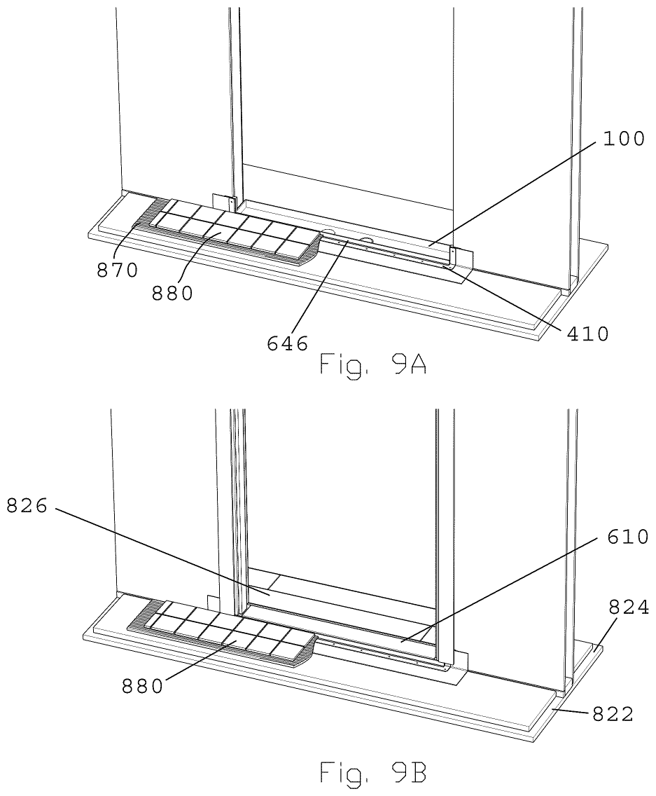

In the fourth step 940, shown in FIG. 9A, the user adds tile adhesive 870 over the top of the membrane 500 and membrane retention piece 400, up to the finishing piece 640. More specifically, the user adds tile adhesive 870 covering a portion of an upper surface of the membrane 500 and the first section 410 of the membrane retention piece 400, as well as covering a portion of a side surface 646 of the finishing piece 640.

Tiling 880 is then added on top of the tile adhesive 870. More specifically, tiling 880 is added covering the tile adhesive 870, terminating at the side surface of the finishing piece 640. In a preferred configuration, a top surface of the tiling 880 is coplanar with a top surface of the finishing piece 640.

The cover 610 is placed into position, at least partially covering the channel 210. The cover 610 is arranged such that there are two fluid gaps extending adjacent a portion of each of the channel side walls 240.

In the fifth step 950, shown in FIG. 9B, a user, for example a carpenter, then mounts a door frame 890, and a door (not shown). The user installs a finished layer 826 on a second side 824 of the floor 820. In the shown example, the finished layer is a wooden floor. The second side 824 of the floor 820 corresponds with the second space, e.g. a dry room. The device system 150 sits flush with the finished layers of the first and second sides 822, 824 of the floor 820, being the tiling 880 and the finished layer 826.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A drain for a rough opening, wherein:
the drain comprises:
an imaginary width axis;
an imaginary depth axis and
an imaginary height axis, wherein:
a first width direction extends parallel to the width axis in a first direction;
a second width direction extends opposite the first width direction in a second direction;
a first depth direction extends parallel to the depth axis in a third direction;
a second depth direction extends opposite the first depth direction in a fourth direction;
a first height direction extends parallel to the height axis in a fifth direction; and
a second height direction extends opposite the first height direction in a sixth direction;
the drain further comprises:
a main body comprising:
a channel wall forming a channel extending in the first width direction, the channel wall comprising:
first and second channel side walls extending in the first with direction;
and
first and second channel end walls extending between the first and second channel side walls in the first depth direction;
a first side flange arranged at the first channel end wall, the first side flange extending further in the first height direction than the first channel end wall; and
a second side flange arranged at the second channel end wall, the second side flange extending further in the first height direction than the first channel end wall,
wherein
the first side flange has a width extending in the first width direction and a thickness extending in the first depth direction the width being larger than the thickness;
the second side flange has a width extending in the first width direction and a thickness extending in the first depth direction, the width being larger than the thickness;
the first side flange projects beyond the channel in the first width direction;
the second side flange projects beyond the channel in the second width direction;
the first side flange and second side flange are each provided with a side surface extending in the first width direction and the first height direction.

2. The drain according to claim 1, wherein the drain comprises a front flange extending:
in the first width direction between the first side flange and the second side flange; and
in the first depth direction, wherein
the front flange comprises an upper surface extending in the first width direction and the first depth direction; and
the upper surface of the front flange and each of the side surfaces of the first and second side flanges provide an L-shaped surface for fastening a membrane thereto.

3. The drain according to claim 1, wherein the channel comprises a drainage aperture for draining water therethrough.

4. A drain system for a rough opening, wherein the drain system comprises:
a drain according to claim 1,
a membrane for fastening to at least the side surfaces of the first side flange and the second side flange.

5. The drain system according to claim 4, wherein the drain system comprises the membrane for fastening to the side surfaces of the first side flange the side surface of the second side flange and an upper surface of a front flange of the drain.

6. The drain system according to claim 4, wherein the drain system comprises a membrane retention piece for fastening the membrane to the drain.

7. The drain system according to claim 4, wherein the drain system comprises a finishing piece extending along one of the channel side walls.

8. The drain system according to claim 7, wherein the finishing piece is positioned in a recess extending in the first width direction.

9. The drain system according to claim 4. wherein the drain system comprises a moisture detector.

10. A method for installing a drain in a rough opening, wherein the method comprising the steps of:
providing the drain system according to claim 4.
positioning the drain in the rough opening between a first space and a second space, the first space being a wet room, such that the first side flange and the second side flange project into the first space in the first depth direction;
pouring concrete on a floor up to a portion of the drain;
fastening the membrane to the drain; and
coupling at least one side jamb of a door frame to the rough opening such that the at least one side jamb is arranged above and across a portion of the channel at one of the channel end walls.

11. The method according to claim 10, wherein the membrane is fastened to the drain using a membrane retention piece for fastening the membrane to the drain.

12. The method according to claim 10 wherein the rough opening is formed by vertical supports, and the first side flange and the second side flange are each fastened to a respective vertical support.

13. The method according to claim 10, wherein the concrete is poured on the floor until the concrete is flush with the an upper surface a front flange of the drain.

14. The method according to claim 10, wherein a finishing piece of the drain system is positioned in the a recess extending in the width direction and edselected such that a top surface of the finishing piece corresponds with a top layer of a surface in which the drain is installed and/or to which the drain is adjacent.

15. The method according to claim 14, wherein a tile adhesive is added to cover a portion of an upper surface of the membrane and a first section of a membrane retention piece for fastening the membrane to the drain, as well as covering a portion of a side surface of the finishing piece a tiling is thereafter added on top of the tile adhesive to cover the tile adhesive terminating at the side face-surface of the finishing piece.

16. The method according to claim 15, wherein the top surface of the tiling is coplanar with the top surface of the finishing piece.

17. A drain system for a rough opening, wherein the drain system comprises:
a drain according to claim 2,
a membrane for fastening to at least the side surfaces of the first side flange and the second side flange.

18. A drain system for a rough opening, wherein the drain system comprises:
a drain according to claim 3,
a membrane for fastening to at least the side surfaces of the first side flange and the second side flange.

19. The drain system according to claim 5, wherein the drain system comprises a membrane retention piece for fastening the membrane to the drain.
